(19) United States
(12) Patent Application Publication
(10) Pub. No.: US 2020/0063653 A1
(43) Pub. Date: Feb. 27, 2020

(54) ENGINE DEVICE

(71) Applicant: Yanmar Co., Ltd., Osaka-shi, Osaka-fu (JP)

(72) Inventors: Masato SUGIMOTO, Osaka-shi (JP); Kota TAKAMATSU, Osaka-shi (JP)

(73) Assignee: Yanmar Co., Ltd., Osaka-shi, Osaka-fu (JP)

(21) Appl. No.: 16/498,833

(22) PCT Filed: Jan. 29, 2018
(86) PCT No.: PCT/JP2018/002708

§ 371 Date: Sep. 27, 2019

(30) Foreign Application Priority Data
Mar. 29, 2017 (JP) 2017-066460

(51) Int. Cl. F02B 43/00; F01N 5/02

(52) U.S. Cl. CPC F02B 43/00; F02M 21/06; F01N 5/02

(57) ABSTRACT

An engine device including an engine and a carburetor that vaporizes a liquefied fuel gas from a fuel gas source for storing a liquefied fuel gas, in which a part of coolant in the engine is distributed to the carburetor. The engine device further includes a water-cooled exhaust manifold having a coolant passage for cooling an exhaust gas passage and a path switching mechanism for connecting a coolant inlet of the carburetor to a carburetor coolant outlet of the engine or to a coolant outlet of the water-cooled exhaust manifold.

### TECHNICAL FIELD

The present invention relates to an engine device that rotates an output shaft based on combustion using a fuel gas.

### BACKGROUND ART

There has been provided a gas engine that is driven by igniting an air-fuel mixture of a fuel gas and air by an ignition device (ignition plug) (see, for example, Patent Literature 1: PTL 1). In a gas engine described in PTL 1, coolant is circulated in a vaporizer (carburetor) for vaporizing a liquefied gas from a liquefied gas source for storing a liquefied fuel gas. The circulation of the coolant to the vaporizer is carried out by using a part of coolant warmed through the inside of the engine in order to prevent or reduce freezing of the vaporizer and to liquefy fuel with stability.

### CITATION LIST

### Patent Literature

PTL 1: Japanese Patent Application Laid-Open No. H07-293345 (1995)

### SUMMARY OF INVENTION

### Technical Problem

In the engine device described as a technique employed to date, in start-up at low temperature, although the engine has been started, coolant is still cold, and a temperature decrease of a vaporizer body caused by heat of fuel vaporization causes the vaporizer to be frozen so that a liquefied fuel gas is not vaporized, which might cause an engine stall.

### Solution to Problem

A technical issue of some aspects of the present invention is to provide an engine device improved based on studies on the existing circumstances as mentioned above.

An engine device according to an aspect of the present invention includes: an engine; a carburetor that vaporizes a liquefied fuel gas from a fuel gas source, the fuel gas source being configured to store a liquefied fuel gas, a part of coolant in the engine being distributed to the carburetor; a water-cooled exhaust manifold including a coolant passage for cooling an exhaust gas passage; and a path switching mechanism that connects a coolant inlet of the carburetor to either a carburetor coolant outlet of the engine or a coolant outlet of the water-cooled exhaust manifold.

In the engine device of the aspect of the present invention, for example, if each of the coolant temperature and the intake air temperature of the engine is less than or equal to the predetermined threshold, the coolant outlet of the water-cooled exhaust manifold may be connected to the coolant inlet of the carburetor through the bypass path.

In the engine device of the aspect of the embodiment, if an air-fuel ratio of an air-fuel mixture of a fuel gas and air in the engine is lower than a predetermined threshold, the coolant outlet of the water-cooled exhaust manifold is connected to the coolant inlet of the carburetor through a bypass path.

In the engine device of the aspect of the embodiment, the path switching mechanism may include a bypass path that connects the coolant outlet of the water-cooled exhaust manifold to the coolant inlet of the carburetor, a downstream valve that switches and connects the coolant outlet of the water-cooled exhaust manifold to the bypass path or to the engine, and an upstream valve that switches and connects the coolant inlet of the carburetor to the bypass path or to the engine.

### Advantageous Effects of Invention

In the engine device according to the aspect of the present includes the engine and the carburetor for vaporizing a liquefied fuel gas from a fuel gas source for storing the liquefied fuel gas, and a part of coolant in the engine is distributed in the carburetor. The engine device includes the water-cooled exhaust manifold having a coolant passage for cooling an exhaust gas passage and a path switching mechanism for connecting the coolant inlet of the carburetor to the carburetor coolant outlet of the engine or the coolant outlet of the water-cooled exhaust manifold. Thus, by connecting the coolant inlet of the carburetor to the coolant outlet of the water-cooled exhaust manifold, coolant in the water-cooled exhaust manifold that is likely to reach a high temperature more quickly than coolant in the engine after engine start can be directly supplied to the carburetor. Accordingly, in a case where freezing of the vaporizer is expected, such as in low-temperature start, freezing of the vaporizer can be suppressed, and an engine stall due to freezing of the vaporizer can be prevented or reduced, resulting in enhancement of engine startability.

In the engine device according to the aspect of the present invention, for example, if each of the coolant temperature and the intake air temperature of the engine is less than or equal to the predetermined threshold, the coolant outlet of the water-cooled exhaust manifold may be connected to the coolant inlet of the carburetor through the bypass path. Then, freezing of the carburetor can be predicted by using existing devices such as coolant temperature sensor and an intake-air temperature sensor, and thus, a dedicated temperature sensor does not need to be provided to the carburetor. A result, an increase in manufacturing costs of the engine device can be suppressed with cost reduction of the configuration.

In the engine device according to the aspect of the present, for example, if the air-fuel ratio of the air-fuel mixture of a fuel gas and air in the engine is lower than the predetermined threshold, the coolant outlet of the water-cooled exhaust manifold may be connected to the coolant inlet of the carburetor through the bypass path. Then, freezing of the carburetor can be predicted by using a characteristic in which when carburetor tends to be frozen, it is more difficult to vaporize a liquefied fuel gas and the air-fuel ratio tends to be small (lean). Thus, a dedicated temperature sensor or the like does not need to be provided to the carburetor. Accordingly, an increase in manufacturing costs of the engine device can be suppressed with cost reduction for the configuration.

In the engine device according to the aspect of the present invention, for example, the path switching mechanism may include a bypass path that connects the coolant outlet of the water-cooled exhaust manifold to the coolant inlet of the carburetor, a downstream valve that switches and connects the coolant outlet of the water-cooled exhaust manifold to the bypass path or to the engine, and an upstream valve that switches and connects the coolant inlet of the carburetor to the bypass path or to the engine. Then, only by adding a simple configuration including the water-cooled exhaust manifold, one bypass path, and two valves to an existing configuration, coolant in the water-cooled exhaust manifold can be directly supplied to the carburetor.

### BRIEF DESCRIPTION OF DRAWINGS

FIG. 1 A schematic perspective view of an engine according to one embodiment when seen from right front.

FIG. 2 A schematic perspective view of the engine seen from left rear.

FIG. 3 A schematic perspective view illustrating the engine in an enlarged manner.

FIG. 4 A schematic perspective view illustrating an engine device according to one embodiment.

FIG. 5 A schematic cross-sectional view of an exhaust manifold.

FIG. 6 A schematic configuration diagram illustrating a coolant system of the engine device.

FIG. 7 A flowchart depicting vaporizer antifreezing control of the engine device.

FIG. 8 A schematic configuration diagram illustrating a coolant system of an engine device according to another embodiment.

FIG. 9 A flowchart depicting vaporizer antifreezing control of the engine device.

FIG. 10 A schematic configuration diagram illustrating a coolant system of an engine device according to yet another embodiment.

### DESCRIPTION OF EMBODIMENTS

In the following, an engine device 200 according to one embodiment of the present invention will be described with reference to the drawings. The engine device 200 includes an engine 1 constituted by a gas engine and a vaporizer (carburetor) 101. In the following description, when the terms indicating specific directions and positions (e.g., “left and right” and “top and bottom”) are used as necessary, a side of the engine 1 toward an intake manifold 3 is described as a left side of the engine 1, a side of the engine 1 toward an exhaust manifold 6 is described as a right side of the engine 1, a side toward a flywheel housing 7 is described as a front side of the engine 1, and a side toward a transmission belt 18 is described as a rear side of the engine 1. These terms are used for convenience of explanation, and are not intended to limit the technical scope of the invention.

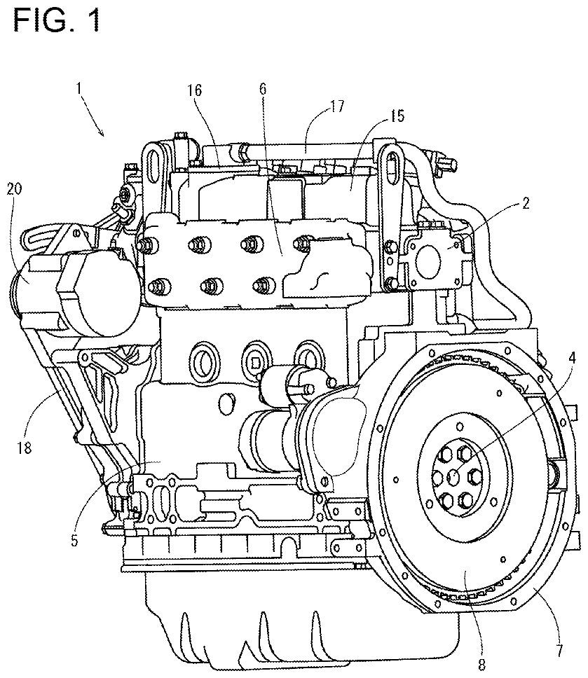

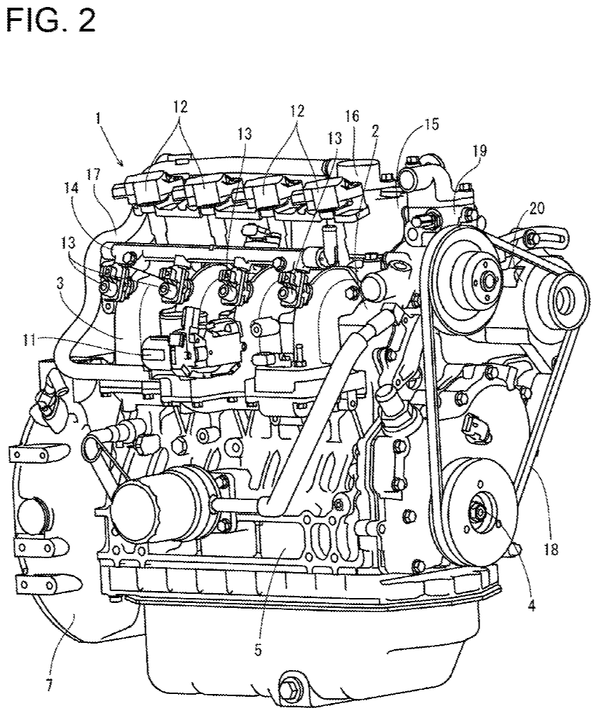

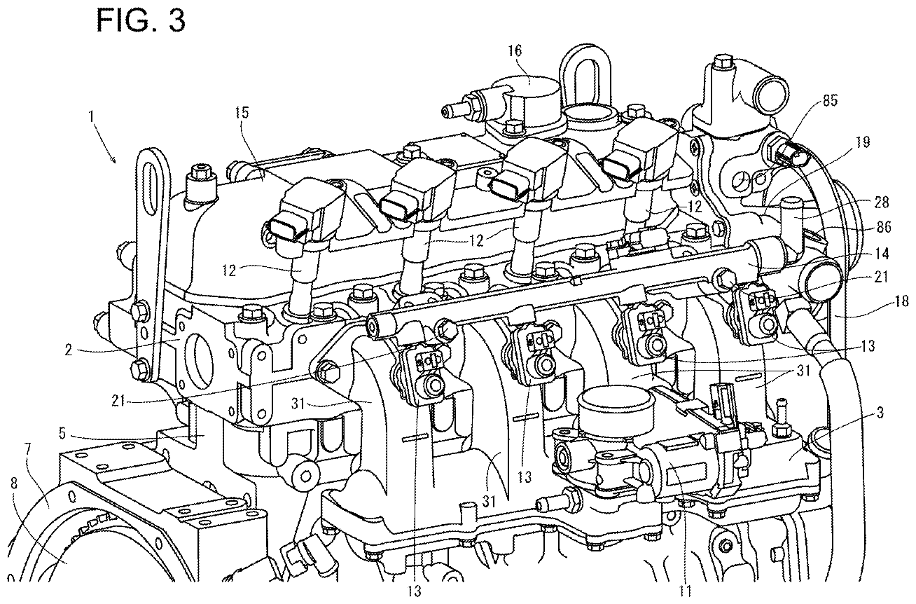

The engine 1 is configured to be driven by a premixed combustion system in which a fuel gas such as a natural gas is mixed with air and subjected to combustion. As illustrating FIGS. 1 through 3, the intake manifold 3 is disposed on a left side surface of a cylinder head 2 located in an upper portion of the engine 1. The cylinder head 2 is mounted on a cylinder block 5 incorporating an engine output shaft 4 (crankshaft) and a plurality of cylinders (not shown). The exhaust manifold 6 is disposed on a right side surface of the cylinder head 2. Front and rear distal ends of the engine output shaft 4 protrude from the front and rear side surfaces of the cylinder block 5.

The engine 1 has a configuration in which a plurality of cylinders are arranged in series in the cylinder block 5. Each cylinder in the cylinder block 5 communicates with the intake manifold 3 disposed at a left side surface of the cylinder head 2. Although not specifically shown, an air cleaner that purifies outdoor air with removal of dust and takes the resulting air through an intake air throttle valve 11 is connected to the intake manifold 3. Ignition devices 12 individually associated with the cylinders and configured to ignite premixed gas in the cylinders are disposed on a left portion (near the intake manifold 3) of the upper surface of the cylinder head 2. Each of the ignition devices 12 generates spark discharge by high voltage in the cylinder to cause combustion of the premixed gas in the cylinder. The combustion of the premixed gas causes a piston in the cylinder to reciprocate so that the engine output shaft 4 is driven to rotate, and power of the engine 1 is generated.

The intake manifold 3 fixed to the left side surface of the cylinder head 2 includes intake branch pipes 31 in the same number as the cylinders, and gas injectors 13 are inserted in the intake branch pipes 31. The gas injectors 13 in the same number of the cylinders are coupled to a fuel gas supply rail 14 extending in the front-rear directions (in parallel with the engine output shaft 4) above the intake manifold 3. The fuel gas supply rail 14 is fixed and fastened to the intake manifold 3 with bolts 21.

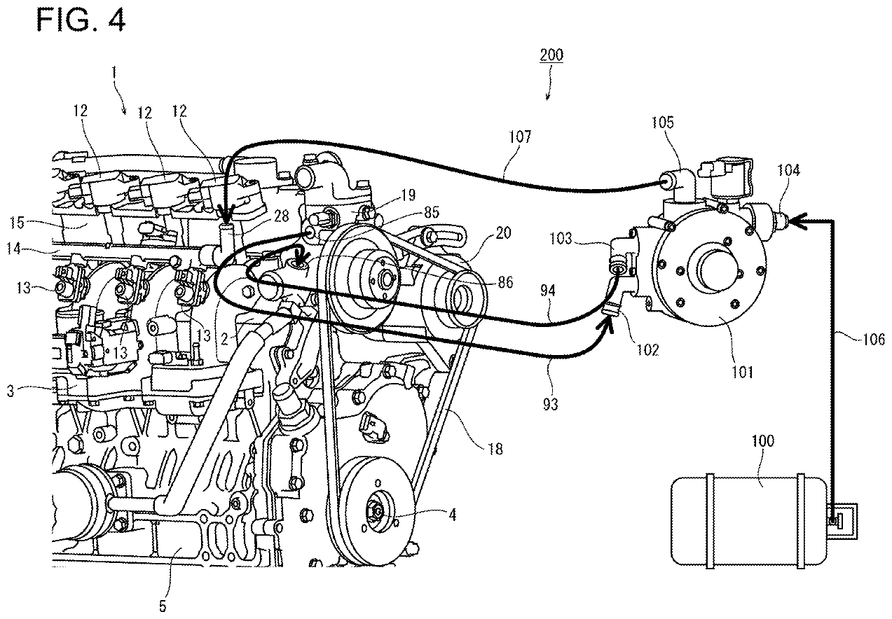

As illustrated in FIG. 4, a gas inlet 28 of the fuel gas supply rail 14 is connected to a gas cylinder 100 through the vaporizer 101. The gas cylinder 100 stores a liquid fuel gas, and after the fuel gas in the gas cylinder 100 is vaporized by the vaporizer 101, the resulting gas is supplied to the gas injectors 13 through the fuel gas supply rail 14. The gas injectors 13 injects the fuel gas into the intake branch pipes 31 so that fresh air and a fuel gas in the intake manifold 3 are mixed and stirred in the intake branch pipes 31 and are supplied to intake ports of the cylinders in the cylinder block 5. The cylinders in the cylinder block 5 communicate with not only the intake manifold 3 but also the exhaust manifold 6 fixed to the right side surface of the cylinder head 2, and an exhaust gas is exhausted to the exhaust manifold 6 through exhaust ports in the cylinders.

A right portion of the upper surface of the cylinder head 2 is covered with a head cover 15, and a rocker arm chamber (not shown) is defined in the head cover 15. The plurality of ignition devices 12 are arranged in the front-rear direction and inserted in a left portion of the upper surface of the cylinder head 2 not covered with the head cover 15 (exposed portions of the upper surface of the cylinder head 2). On the right portion of the upper surface of the cylinder head 2, an intake valve and an exhaust valve (not shown), for example, are covered with the head cover 15.

In a rear portion of the head cover 15, a blow-by gas reduction device 16 for separating lubricating oil from a blow-by gas that has leaked from, for example, combustion chambers of the cylinders toward the upper surface of the cylinder head 2 is formed. The blow-by gas reduction device 16 communicates with the intake manifold 6 through a blow-by gas return pipe 17. The blow-by gas that has leaked from combustion chambers defined in the cylinder head 2 and the cylinder block 5 are supplied to the intake manifold 6 through the blow-by gas reduction device 16 and the blow-by gas return pipe 17, and then, is merged with fresh air supplied to the intake manifold 6 through the intake air throttle valve 11. Then, the blow-by gas merged with fresh air in the intake manifold 6 is sent to the combustion chambers (reduced) again so that the blow-by gas is not released to the atmosphere.

The engine 1 includes a coolant pump 19 for allowing a coolant to circulate in, for example, the cylinder head 2 and the cylinder block 5 and in the radiator (not shown), and an alternator 20 for charging a battery (not shown). The coolant pump 19 and the alternator 20 are coupled to a left projection end of the engine output shaft 4 through, for example, the transmission belt 18. A rotative force of the engine output shaft 4 is transferred to the coolant pump 19 by way of the transmission belt 18 to drive the coolant pump 19 so that coolant is circulated in the cylinder head 2 and the cylinder block 5 and in the radiator, for example. On the other hand, a rotative force of the engine output shaft 4 is transferred to the alternator 20 by way of the transmission belt 18 to drive the alternator 20 so that the battery (not shown) is charged with electric power generated by the alternator 20. In this embodiment, the coolant pump 19 is attached to an upper portion in a rear portion of the engine 1, and the alternator 20 is attached to a right portion of the rear portion of the engine 1.

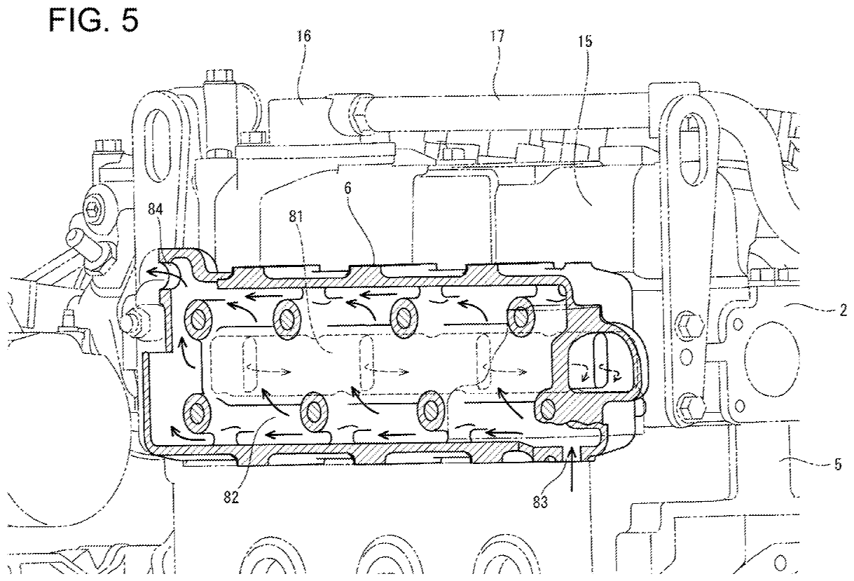

As illustrated in FIG. 5, the exhaust manifold 6 is constituted by a water-cooled exhaust manifold. That is, the exhaust manifold 6 includes an exhaust gas passage 81 communicating with the cylinders in the cylinder block 5 through the cylinder head 2, and a coolant passage 82 for cooling the exhaust gas passage 81. An exhaust gas from the cylinders of the engine 1 is emitted from the right side surface of the cylinder head 2. Then, as indicated by broken arrows, an exhaust gas is taken and merged in the exhaust gas passage 81 of the exhaust manifold 6, and then emitted from an exhaust gas outlet in a front portion of the exhaust manifold 6. The exhaust gas emitted from the exhaust manifold 6 is released to the outside through an exhaust gas purifier (not shown), for example.

Coolant is introduced into an upstream portion (front portion) of the coolant passage 82 from a coolant inlet 83 disposed in a front end part of a lower portion of the exhaust manifold 6. As indicated by solid arrows, the introduced coolant flows in the coolant passage 82 toward the rear of the engine 1 while contacting an outer wall of the exhaust gas passage 81. The coolant that has reached the lower portion (rear portion) of the coolant passage 82 flows out of the coolant passage 82 from a coolant outlet 84 disposed in a rear end part of an upper portion of the exhaust manifold 6.

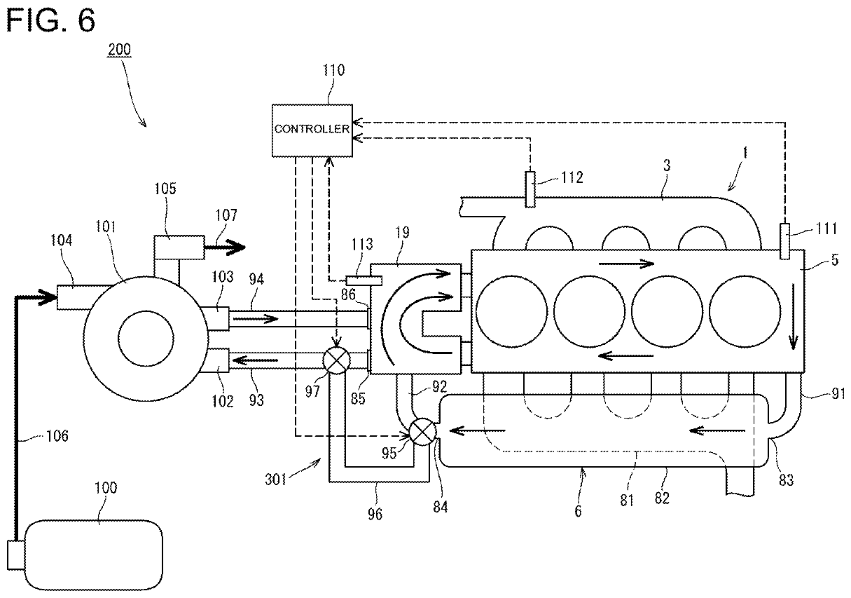

As illustrated in FIG. 6, in this embodiment, the coolant inlet 83 of the exhaust manifold 6 is connected to the coolant passage in the cylinder block 5 through an upstream coolant path 91. The coolant outlet 84 of the exhaust manifold 6 is connected to the coolant pump 19 through a downstream coolant path 92. By driving of the coolant pump 19, a coolant is distributed in the cylinder head 2 (see, for example, FIG. 1) and the coolant passage in the cylinder block 5 so that the engine 1 is cooled.

A part of the coolant distributed in the coolant passage in the cylinder block 5 is introduced to the coolant passage 82 through the upstream coolant path 91 and the coolant inlet 83 of the exhaust manifold 6 and cools an exhaust gas distributed in the exhaust gas passage 81. The coolant that has passed through the coolant passage 82 flows into the coolant pump 19 through the coolant outlet 84 and the downstream coolant path 92.

As illustrated in FIGS. 4 and 6, the coolant pump 19 of the engine 1 has a carburetor coolant outlet 85 and a carburetor coolant inlet 86. The carburetor coolant outlet 85 is connected to the coolant inlet 102 of the vaporizer 101 through a carburetor coolant sending path 93. The carburetor coolant inlet 86 is connected to the coolant outlet 103 of the vaporizer 101 through a carburetor coolant return path 94. By driving the coolant pump 19, a part of the coolant that has passed through the inside of the engine 1 is distributed to the vaporizer 101. Accordingly, the vaporizer 101 is warmed so that freezing of the vaporizer 101 can be prevented or reduced and fuel vaporization in the vaporizer 101 can be stabilized.

A liquefied fuel gas inlet 104 of the vaporizer 101 is connected to the gas cylinder 100 as an example of a fuel gas source through a liquefied fuel gas path 106 constituted by a pipe. A fuel gas outlet 105 of the vaporizer 101 is connected to the gas inlet 28 of the engine 1 through a fuel gas path 107 constituted by a pipe. A liquefied fuel gas supplied from the gas cylinder 100 is introduced from the liquefied fuel gas inlet 104 into the vaporizer 101 through the liquefied fuel gas path 106, and is vaporized in the vaporizer 101. The fuel gas vaporized in the vaporizer 101 is sent to the gas inlet 28 of the engine 1 from the fuel gas outlet 105 through the fuel gas path 107.

As illustrated in FIG. 6, a bypass path 96 is provided to connect the coolant outlet 84 of the exhaust manifold 6 to the coolant inlet 102 of the vaporizer 101 without interposition of a coolant distribution path inside the engine 1. An end (upstream end) of the bypass path 96 is connected to an intermediate portion of the downstream coolant path 92 communicating with the coolant outlet 84 of the exhaust manifold 6 through a switching valve 95 of, for example, a three-way valve. The other end (lower end) of the bypass path 96 is connected to an intermediate portion of the coolant sending path 93 communicating with the coolant inlet 102 of the vaporizer 101 through a switching valve 97 of, for example, a three-way valve. The bypass path 96 and the switching valves 95 and 97 constitute a path switching mechanism 301 that connects the coolant inlet 102 of the vaporizer 101 to the carburetor coolant outlet 85 of the engine 1 or the coolant outlet 84 of the exhaust manifold 6. The switching valve 95 is an example of an upstream valve, and the switching valve 97 is an example of a downstream valve.

The switching valves 95 and 97 are, for example, electromagnetic valves or motor-operated valves, and are electrically connected to a controller 110 constituted by an engine control unit or electronic control unit (ECU). The controller 110 controls electronic auxiliary devices of the engine 1 including the switching valves 95 and 97 to control operation of the engine 1. Although not specifically described, the controller 110 includes, in addition to a central processing unit (CPU) for executing various computation processes and control, a read only memory (ROM) for fixedly storing various types of data, an electrically erasable ROM (EEPROM) for rewritably storing control programs and various types of data, a random access memory (RAM) for temporarily storing control programs and various types of data, a timer for measuring time, and an input/output interface, for example.

In this embodiment, in regard to control of the switching valves 95 and 97 in connecting the coolant outlet 84 of the exhaust manifold 6 directly to the vaporizer 101, an oil temperature sensor 111, an intake-air temperature sensor 112, and a coolant temperature sensor 113 are electrically connected to an input side of the controller 110. The oil temperature sensor 111 is configured to detect a temperature of lubricating oil in the engine 1, and is attached to the cylinder block 5 in this embodiment. The intake-air temperature sensor 112 is constituted by, for example, a temperature-manifold absolute pressure sensor (T-MAPS), and detects an intake-air temperature and an intake-air pressure in the intake manifold 3. The coolant temperature sensor 113 is configured to detect the temperature of coolant distributed in the engine 1, and is attached to the coolant pump 19 in this embodiment.

The switching valves 95 and 97 are electrically connected to the output side of the controller 110. Although not shown, various sensors and other components provided in the engine 1 are electrically connected to the input side of the controller 110, and various devices and other components provided in the engine 1 are electrically connected to the output side of the controller 110.

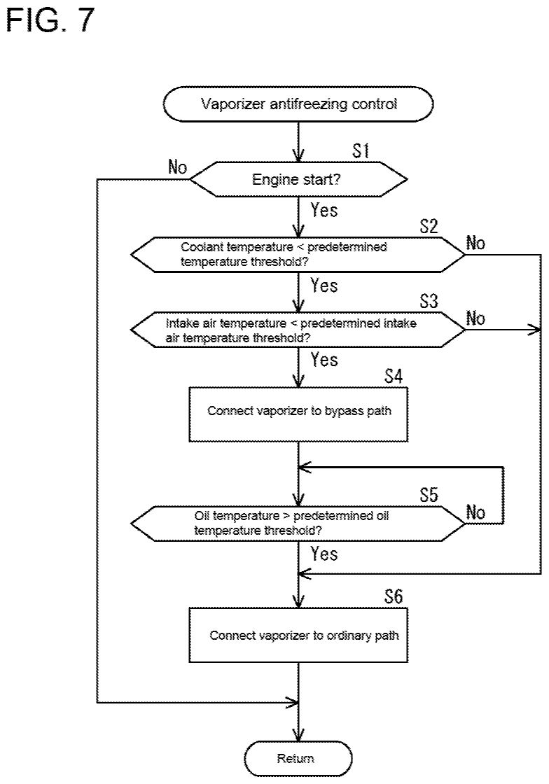

Next, with reference to FIG. 7, a flow of vaporizer antifreezing control in the engine device 200 will be described. The controller 110 controls the switching valves 95 and 97 so as to connect the coolant inlet 102 of the vaporizer 101 to the coolant outlet 84 of the exhaust manifold 6 through the bypass path 96 when freezing of the vaporizer 101 is predicted, for example, when the engine 1 is started at low temperature.

When the engine 1 is started (step S1, Yes), the controller 110 determines whether a coolant temperature measured from an output of the coolant temperature sensor 113 is lower than a predetermined coolant temperature threshold or not (step S2). If the coolant temperature is lower than the predetermined coolant temperature threshold (step S2, Yes), it is predicted that the engine 1 is cold-started. At this time, the controller 110 determines whether the intake air temperature measured from an output of the intake-air temperature sensor 112 is lower than a predetermined intake air temperature threshold or not (step S3).

If the intake air temperature is lower than the predetermined intake air temperature threshold (step S3, Yes), it is predicted that an ambient of the engine device 200 is at a low temperature. At this time, the controller 110 switches the switching valves 95 and 97 to connect the coolant outlet 84 of the exhaust manifold 6 to the coolant inlet 102 of the vaporizer 101 through the bypass path 96 (step S4). That is, the switching valve 95 connects the coolant outlet 84 of the exhaust manifold 6 to the bypass path 96, and disconnects a coolant path between the coolant outlet 84 of the exhaust manifold 6 and the coolant pump 19. The switching valve 97 connects the bypass path 96 to an intermediate portion of the coolant sending path 93, and disconnects a coolant path between the carburetor coolant outlet 85 and the vaporizer 101.

In distributing coolant to the vaporizer 101 by way of the bypass path 96, the coolant outlet 84 of the exhaust manifold 6 is connected to the coolant inlet 102 of the vaporizer 101 without interposition of the coolant distribution path in the engine 1. Then, coolant in the exhaust manifold 6 that is likely to reach a high temperature more quickly than coolant in the engine 1 after engine start-up can be directly supplied to the vaporizer 101. Accordingly, in a case where freezing of the vaporizer 101 is expected, such as in low-temperature start, freezing of the vaporizer 101 can be suppressed, and an engine stall due to freezing of the vaporizer 101 can be prevented or reduced, resulting in enhancement of engine startability.

When driving of the engine 1 continues and the oil temperature measured from an output of the oil temperature sensor 111 exceeds a predetermined oil temperature threshold (step S5, Yes), the controller 110 switches the switching valves 95 and 97 to change the coolant distribution path to the vaporizer 101 to an ordinary path (step S6). That is, the switching valve 95 connects the coolant outlet 84 of the exhaust manifold 6 to the coolant pump 19 through the downstream coolant path 92. The switching valve 97 connects a coolant outlet 85 to the coolant inlet 102 of the vaporizer 101. Accordingly, the coolant path connected to the bypass path 96 is disconnected. In the state where oil temperature exceeds the predetermined oil temperature threshold, coolant in the engine 1 is sufficiently warmed. Thus, coolant does not need to be directly distributed from the exhaust manifold 6 to the vaporizer 101 through the bypass path 96, and freezing of the vaporizer 101 can be prevented or reduced by using coolant that has flowed from the carburetor coolant outlet 85.

After start-up of the engine 1 (step S1, Yes), if the coolant temperature is greater than or equal to the predetermined coolant temperature threshold (step S2, No) or if the intake air temperature is lower than the predetermined intake air temperature threshold (step S3, Yes), the controller 110 controls the switching valves 95 and 97 such that the coolant distribution path to the vaporizer 101 is the ordinary path (step S6).

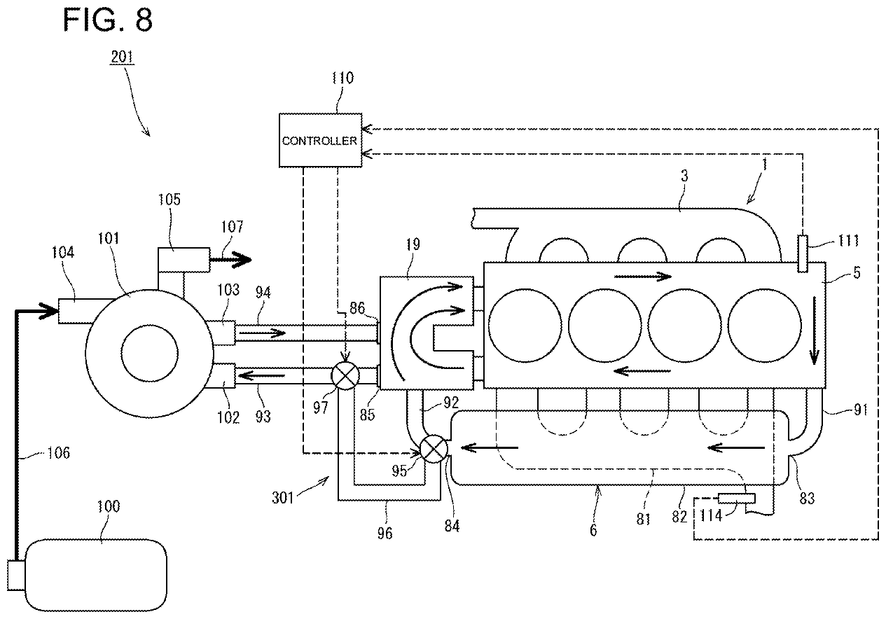

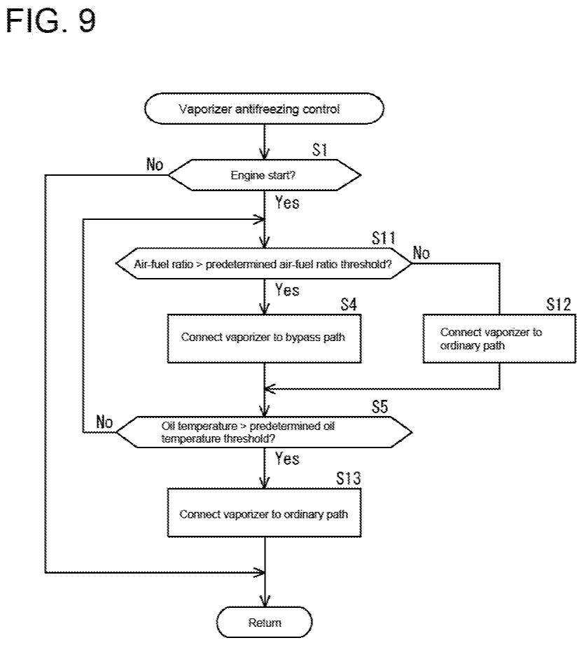

Next, another embodiment of the engine device will be described with reference to FIGS. 8 and 9. As illustrated in FIG. 8, an engine device 201 according to this embodiment is different from the engine device 200 of the embodiment described above in including an air-fuel ratio sensor 114 and predicting freezing of the vaporizer 101 by the controller 110 based on an output of the air-fuel ratio sensor 114. The other part of the configuration of the engine device 201 is similar to the configuration of the engine device 200. Although not shown in FIG. 8, the engine device 201 includes various sensors as well as the air-fuel ratio sensor 114, such as an intake-air temperature sensor 112 and a coolant temperature sensor 113 (see FIG. 6).

The air-fuel ratio sensor 114 is configured to detect an oxygen concentration in an exhaust gas, and is attached to an exhaust gas passage 81 of an exhaust manifold 6 in this embodiment. The air-fuel ratio sensor 114 is electrically connected to a controller 110. The controller 110 measures an air-fuel ratio between air and a fuel gas supplied to cylinders in a cylinder block 5 from an output of the air-fuel ratio sensor 114.

With reference to FIG. 9, a flow of vaporizer antifreezing control in the engine device 201 will be described. In a manner similar to the engine device 200 of the embodiment described above, in the engine device 201, the controller 110 controls the switching valves 95 and 97 so as to connect a coolant inlet 102 of a vaporizer 101 to a coolant outlet 84 of the exhaust manifold 6 through a bypass path 96 when freezing of the vaporizer 101 is predicted.

When the engine 1 is started (step S1, Yes), the controller 110 determines whether an air-fuel ratio of an air-fuel mixture measured from an output of the air-fuel ratio sensor 114 is lower than a predetermined air-fuel ratio threshold (lean) or not (step S11). If the air-fuel ratio of the air-fuel mixture is lower than the predetermined air-fuel ratio threshold (step S11, Yes), it is predicted that the vaporizer 101 tends to be frozen. That is, freezing of the vaporizer 101 is predicted by using a characteristic in which when the vaporizer 101 tends to be frozen, it is more difficult to vaporize a liquefied fuel gas and the air-fuel ratio tends to be small (lean). Then, the controller 110 switches the switching valves 95 and 97 to connect the coolant outlet 84 of the exhaust manifold 6 to the coolant inlet 102 of the vaporizer 101 through the bypass path 96 (step S4). The control in step S4 in the engine device 201 is the same as the control in step S4 (see FIG. 7) in the engine device 200 of the embodiment described above.

That is, in a manner similar to the engine device 200 of the embodiment described above, in the engine device 201, in a case where freezing of the vaporizer 101 is predicted, coolant in the exhaust manifold 6 that is likely to reach a high temperature more quickly than coolant in the engine 1 after engine start-up can be directly supplied to the vaporizer 101. Accordingly, in a case where freezing of the vaporizer 101 is expected, such as in low-temperature start, freezing of the vaporizer 101 can be suppressed, and an engine stall due to freezing of the vaporizer 101 can be prevented or reduced, resulting in enhancement of engine startability.

After start-up of the engine 1 (step S1, Yes), if the air-fuel ratio of the air-fuel mixture is less than or equal to the predetermined air-fuel ratio threshold (step S11, No), it is predicted that the vaporizer 101 does not tend to be frozen and vaporization of a fuel gas is normally performed. At this time, the controller 110 controls switching valves 95 and 97 such that the coolant distribution path to the vaporizer 101 is the ordinary path (step S12).

The controller 110 monitors the air-fuel ratio of the air-fuel mixture until the oil temperature measured from an output of the oil temperature sensor 111 exceeds the predetermined oil temperature threshold (step S5, No, step S11). If driving of the engine 1 continues and the oil temperature exceeds the predetermined oil temperature threshold (step S5, Yes), the controller 110 controls the switching valves 95 and 97 such that the coolant distribution path to the vaporizer 101 is the ordinary path (step S13). When the oil temperature exceeds the predetermined oil temperature threshold (step S5, Yes), if coolant is supplied to the vaporizer 101 through the bypass path 96, the coolant distribution path to the vaporizer 101 is switched to the ordinary path in a manner similar to the control in step S6 (see FIG. 7) in the engine device 200 of the embodiment described above.

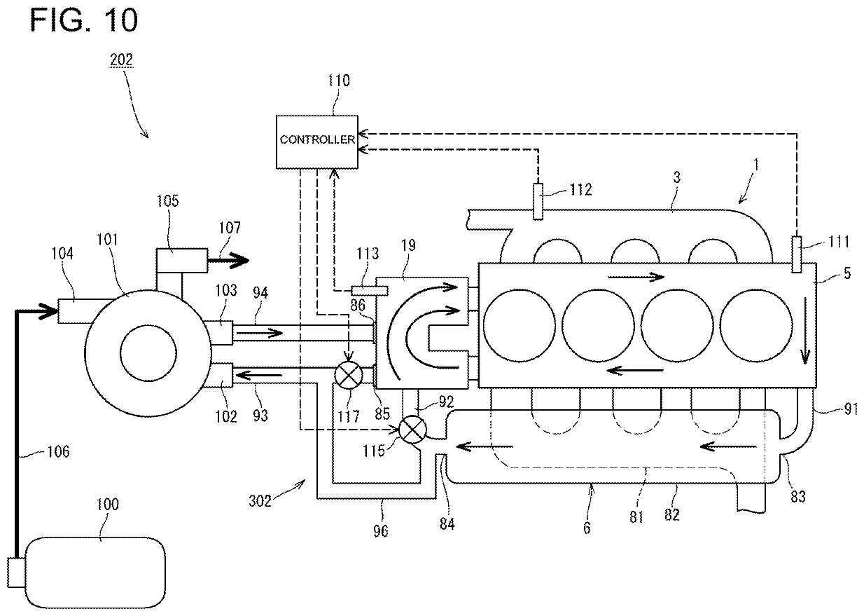

Next, yet another embodiment of the engine device will be described with reference to FIG. 10. As compared to the engine device 200 illustrated in FIG. 6, an engine device 202 according to this embodiment includes shut-off valves 115 and 117 instead of the switching valves 95 and 97. The other part of the configuration of the engine device 202 is similar to the configuration of the engine device 200.

The shut-off valve 115 as an example of an upstream valve is disposed downstream of a branch between the downstream coolant path 92 and the bypass path 96 in the downstream coolant path 92. The shut-off valve 117 as an example of a downstream valve is disposed upstream of a branch between the coolant sending path 93 and the bypass path 96 in the coolant sending path 93. The bypass path 96 and the shut-off valves 115 and 117 constitute the path switching mechanism 302 connecting the coolant inlet 102 of the vaporizer 101 to the carburetor coolant outlet 85 of the engine 1 or the coolant outlet 84 of the exhaust manifold 6.

While both the shut-off valves 115 and 117 are open, coolant distributed in the coolant passage 82 of the exhaust manifold 6 flows into the coolant pump 19 through the coolant outlet 84, the downstream coolant path 92, and the shut-off valve 115, and the coolant flows from the carburetor coolant outlet 85 into the coolant inlet 102 of the vaporizer 101 through the coolant sending path 93 and the shut-off valve 117. On the other hand, while both the shut-off valves 115 and 117 are closed, coolant distributed in the coolant passage 82 of the exhaust manifold 6 flows into the coolant inlet 102 of the vaporizer 101 through the coolant outlet 84, the bypass path 96, and the coolant sending path 93.

The shut-off valves 115 and 117 are electrically connected to the controller 110. In a manner similar to the flow of antifreezing control of the vaporizer 101 described with reference to FIG. 7, in a case where freezing of the vaporizer 101 is predicted, the controller 110 switches the shut-off valves 115 and 117 and connects the coolant inlet 102 of the vaporizer 101 to the coolant outlet 84 of the exhaust manifold 6 through the bypass path 96. Accordingly, in a case where freezing of the vaporizer 101 is predicted, such as in low-temperature start, coolant in the exhaust manifold 6 that is likely to reach a high temperature more quickly than coolant in the engine 1 after engine start-up can be directly supplied to the vaporizer 101. Then, an engine stall due to freezing of the vaporizer 101 can be prevented or reduced, resulting in enhancement of engine startability.

The configuration including the shut-off valves 115 and 117 instead of the switching valves 95 and 97 is, of course, applicable to the engine device 201 described with reference to FIG. 8. Other configurations may be employed: the switching valve 95 may be disposed in the downstream coolant path 92 with the shut-off valve 117 disposed in the coolant sending path 93, or the shut-off valve 115 may be disposed in the downstream coolant path 92 with the switching valve 97 disposed in the coolant sending path 93.

The carburetor coolant outlet 85 and the carburetor coolant inlet 86 are disposed in the coolant pump 19 in this embodiment, but may be disposed in other components of the engine 1, such as in the cylinder head 2 or the cylinder block 5.

As illustrated in FIGS. 1 through 6, 8, and 10, the engine device 200, 201, 202 includes the engine 1 and the vaporizer 101 for vaporizing a liquefied fuel gas from the gas cylinder 100 for storing the liquefied fuel gas, and is configured to distribute a part of coolant in the engine 1 to the vaporizer 101. The engine device 200, 201, 202 also includes: the water-cooled exhaust manifold 6 including the coolant passage 82 for cooling the exhaust gas passage 81; and the path switching mechanism 301 or 302 for connecting the coolant inlet 102 of the vaporizer 101 to the carburetor coolant outlet 85 of the engine 1 or the coolant outlet 84 of the exhaust manifold 6. Thus, by connecting the coolant inlet 102 of the vaporizer 101 to the coolant outlet 84 of the exhaust manifold 6, coolant in the exhaust manifold 6 that is more likely to reach a high temperature more quickly than coolant inside the engine 1 after start-up of the engine 1 can be directly supplied to the vaporizer 101. Accordingly, in a case where freezing of the vaporizer 101 is expected, such as in low-temperature start, freezing of the vaporizer 101 can be suppressed, and an engine stall due to freezing of the vaporizer 101 can be prevented or reduced, resulting in enhancement of engine startability.

As illustrated in FIGS. 6 and 7, the engine device 200 is configured such that if each of the coolant temperature and the intake air temperature of the engine 1 is less than or equal to the predetermined threshold, the coolant outlet 84 of the exhaust manifold 6 is connected to the coolant inlet 102 of the vaporizer 101 through the bypass path 96. The engine device 200 can predict freezing of the vaporizer 101 by using existing devices such as the coolant temperature sensor 113 and the intake-air temperature sensor 112, and a dedicated temperature sensor or the like does not need to be provided to the vaporizer 101. Thus, an increase in manufacturing costs of the engine device 200 can be suppressed with cost reduction for the configuration.

As illustrated in FIGS. 8 and 9, the engine device 201 is configured such that the coolant outlet 84 of the exhaust manifold 6 is connected to the coolant inlet 102 of the vaporizer 101 through the bypass path 96 when the air-fuel ratio of an air-fuel mixture of a fuel gas and air in the engine 1 is lower than a predetermined threshold, The engine device 201 can predict freezing of the vaporizer 101 by using a characteristic in which when the vaporizer 101 tends to be frozen, it is more difficult to vaporize the liquefied fuel gas and the air-fuel ratio tends to be low (lean). Thus, a dedicated temperature sensor or the like does not need to be provided to the vaporizer 101 in the engine device 201. Accordingly, an increase in manufacturing costs of the engine device 201 can be suppressed with cost reduction for the configuration.

As illustrated in FIGS. 1 through 6, 8, and 10, in the engine device 200, 201, 202, the path switching mechanism 301, 302 includes the bypass path 96 connecting the water-cooled coolant outlet 84 of the exhaust manifold 6 to the coolant inlet 102 of the vaporizer 101, the switching valve 95 or the shut-off valve 115 as an example of a downstream valve for switching and connecting the water-cooled coolant outlet 84 of the exhaust manifold 6 to the bypass path 96 or to the engine 1; and the switching valve 97 or the shut-off valve 117 as an example of an upstream valve for switching and connecting the coolant inlet 102 of the vaporizer 101 to the bypass path 96 or to the engine 1. Thus, in the engine device 200, 201, 202, only by adding a simple configuration including the water-cooled exhaust manifold 6, one bypass path 96, two switching valves 95 and 97 or two shut-off valves 115 and 117 to an existing configuration, the coolant in the water-cooled exhaust manifold 6 can be directly supplied to the vaporizer 101.

The present invention is not limited to the embodiments described above, but can be embodied into various aspects. The configurations of components in the present invention are not limited to those of the illustrated embodiments, and can be variously changed without departing from the gist of the present invention.

### REFERENCE SIGNS LIST

1 engine
6 exhaust manifold (water-cooled exhaust manifold)
85 carburetor coolant outlet
96 bypass path
100 gas cylinder (fuel gas source)
101 vaporizer (carburetor)
102 coolant inlet
200, 201, 202 engine device
301, 302 path switching mechanism

1. An engine device comprising:
an engine;
a carburetor configured to vaporize a liquefied fuel gas from a fuel gas source, the fuel gas source being configured to store the liquefied fuel gas, and a part of a coolant in the engine being distributed to the carburetor;
a water-cooled exhaust manifold including a coolant passage for cooling an exhaust gas passage; and
a path switching mechanism configured to connect a coolant inlet of the carburetor to either a carburetor coolant outlet of the engine or a coolant outlet of the water-cooled exhaust manifold.

2. The engine device according to claim 1, wherein if each of a coolant temperature and an intake air temperature of the engine is less than or equal to a predetermined threshold, the coolant outlet of the water-cooled exhaust manifold is configured to be connected to the coolant inlet of the carburetor through a bypass path.

3. The engine device according to claim 1, wherein if an air-fuel ratio of an air-fuel mixture of a fuel gas and air in the engine is lower than a predetermined threshold, the coolant outlet of the water-cooled exhaust manifold is configured to be connected to the coolant inlet of the carburetor through a bypass path.

4. The engine device according to claim 1, wherein the path switching mechanism includes:
a bypass path configured to connect the coolant outlet of the water-cooled exhaust manifold to the coolant inlet of the carburetor;
a downstream valve configured to switch and connect the coolant outlet of the water-cooled exhaust manifold to the bypass path or to the engine; and
an upstream valve configured to switch and connect the coolant inlet of the carburetor to the bypass path or to the engine.
